(19) United States
(12) Patent Application Publication
(10) Pub. No.: US 2005/0244561 A1
(43) Pub. Date: Nov. 3, 2005

(54) Carvone acetals used as flavourings

(76) Inventors: Horst Surburg, HOLMINDEN (DE); Hubert Loges, Hoxter (DE); Arnold Machinek, Holzminden (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/521,210

(22) PCT Filed: Aug. 2, 2003
(86) PCT No.: PCT/EP03/08591

§ 371 Date: Jan. 13, 2005

(51) Int. Cl. A23L 1/22

(52) U.S. Cl. 426/534

(57) ABSTRACT

The invention relates to (−)-carvone acetals and their use as flavourings. In a preferred embodiment, the invention relates to the use of these acetals for the flavouring of oral hygiene products.

The invention relates to (−)-carvone acetals of the general formula (I) and their use as flavourings. The invention also relates to flavour and taste compositions and to products containing the (−)-carvone acetals according to the invention, the use of the flavour and taste compositions for the flavouring of products and a process for the flavouring of products with flavour and taste compositions containing the (−)-carvone acetals according to the invention.

(−)-Carvone, which occurs naturally in spearmint oil, is a valuable flavouring with a uniquely typical, warm, sweet, fresh, minty-spicy taste. Like spearmint oil, (−)-carvone is mainly used for the flavouring of foods, items consumed for pleasure, cosmetic products and pharmaceutical preparations. It is mainly used for the flavouring of chewing gums and oral care products. In most areas of application, (−)-carvone is sufficiently stable but when used in products and preparations with a higher pH, difficulties occur because (−)-carvone undergoes chemical and sensory changes under these basic conditions. Products and preparations having a higher pH are e.g. carbonate-based toothpastes or other dental care products, which contain calcium carbonate, sodium hydrogencarbonate or similar substances reacting as alkalis.

A need therefore exists for flavourings with a typical spearmint note which are stable in media in which carvone undergoes chemical and/or sensory changes, e.g. in dental care products reacting as alkalis.

The present invention therefore provides the use of (−)-carvone acetals of the general formula (I), 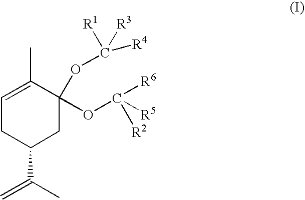
as flavourings,
wherein
R¹ to R⁶ independently of one another denote hydrogen or an alkyl group with 1 to 4 carbon atoms;
or optionally
R⁴ and R⁶ together denote a carbon single bond or a —(CR⁷R⁸)ₓ_{^{−}} group, wherein x can take on the values 1 or 2 and
R⁷ and R⁸ independently of one another denote hydrogen or an alkyl group with 1 to 4 carbon atoms.

The compounds according to the invention produce a strong and typical spearmint taste. This finding is all the more surprising as it is generally known that, during acetalisations of carbonyl compounds, the sensory nature changes and the sensory intensity decreases. It is also surprising that the acetals of general formula (I) give a strong and typical taste impression although their odour can be described as not very distinct and rather atypical.

The acetals according to the invention are therefore outstandingly suitable for use as flavourings with a spearmint taste in the production of flavour and taste compositions. Flavour compositions consist exclusively of volatile, taste-producing substances, while taste compositions can also contain non-volatile substances, which produce e.g. sweet, sour, bitter, pungent and cooling taste impressions.

Flavour and taste compositions containing (−)-carvone acetals of general formula (I) can be used e.g. for flavouring foods, items consumed for pleasure, body care products or pharmaceutical preparations.

Foods and items consumed for pleasure can include confectionery, such as boiled sweets, chewing gums, breath-freshening dragees, tablets and hard toffees.

Body care products can be oral care products, such as toothpastes, tooth gels, dental creams, dental care chewing gums and mouthwashes. Use in oral care products with a fresh, minty and cooling taste is preferred.

Pharmaceutical products can be lozenges, throat pastilles or chewable tablets. Owing to their good alkali stability, flavour compositions with the acetals according to the invention are particularly suitable for the flavouring of antacids.

The flavouring of agents, products, preparations and media reacting as alkalis, having a pH greater than or equal to 7.5, is particularly preferred, especially those with a pH of between 8 and 10, such as e.g. carbonate-based toothpastes.

The alkyl groups with 1 to 4 carbon atoms in formula (I) can be methyl, ethyl, n-propyl, iso-propyl, n-butyl, sec.-butyl, iso-butyl or tert.-butyl groups. Alkyl groups with 1 to 3 carbon atoms, such as methyl, ethyl, n-propyl or iso-propyl groups are preferred, and methyl and ethyl are especially preferred alkyl groups.

The use of carvone acetals of formula (I) in which R¹ to R⁶ denote a hydrogen atom, or R¹ and R² independently of one another denote an alkyl group with 1 to 4 carbon atoms and the residues R³ to R⁶ a hydrogen atom, or R⁴ and R⁶ together represent a carbon single bond and R¹, R², R³ and R⁵, independently of one another, denote a hydrogen atom or an alkyl group with 1 to 4 carbon atoms, is preferred.

The use of (−)-carvone dimethyl acetal, (−)-carvone diethyl acetal, (−)-carvone ethylene glycol acetal, (−)-carvone 1,2-propylene glycol acetal, (−)-carvone 1,2-butylene glycol acetal and (−)-carvone 2,3-butylene glycol acetal is particularly preferred.

The acetals of formula (I) according to the invention can be present and can be used in all the diastereomeric and enantiomeric forms or mixtures thereof.

The compounds (−)-carvone dimethyl acetal, (−)-carvone diethyl acetal and (−)-carvone 1,2-butylene glycol acetal are new.

In Nihon Yukagakkaishi 45, 865-870 (1996), the synthesis and the sensory properties of acetals are described. Among the synthesised compounds is (+)-carvone ethylene glycol acetal, but the sensory properties thereof are not described.

The production of the acetals according to the invention can take place in a manner that is known per se. To produce the acyclic acetals, (−)-carvone is reacted with alkanols in the presence of a dehydrating agent, such as e.g. the corresponding orthoformates of the alkanols used, as described e.g. in Acta Chem. Scand B 41, 442-447 (1987). The cyclic acetals can be obtained by reacting (−)-carvone with diols with azeotropic water separation, catalysed by weakly acidic catalysts (Bull. Soc. Chim. Belg. 102, 79-87 (1993)).

For the flavouring of products, the (−)-carvone acetals according to the invention can be used in pure form, in combination with one another or, in a particularly preferred form, in combination with other flavourings or taste compounds into flavour or taste compositions.

Suitable as flavourings are both complex natural raw materials, such as essential oils and extracts obtained from plants, or fractions and homogeneous substances obtained therefrom, and homogeneous flavourings obtained synthetically or by biotechnology.

Examples of natural raw materials are e.g.:

Peppermint oils, spearmint oils, Mentha arvensis oils, aniseed oils, clove oils, citrus oils, cinnamon bark oils, wintergreen oils, cassia oils, davana oils, fir needle oils, eucalyptus oils, fennel oils, galbanum oils, ginger oils, chamomile oils, caraway seed oils, rose oils, geranium oils, sage oils, milfoil oils, star anise oils, thyme oils, juniper berry oils, rosemary oils, angelica root oils and the fractions of these oils.

Example of homogeneous flavourings are e.g.:

Anethole, menthol, menthone, isomenthone, menthyl acetate, menthofuran, menthyl methyl ether, mint lactone, eucalyptol, limonene, eugenol, pinene, sabinene hydrate, 3-octanol, carvone, gamma-octalactone, gamma-nonalactone, Germacren-D, Viridiflorol, 1,3E,5Z-undecatriene, isopulegol, piperitone, 2-butanone, ethyl formate, 3-octyl acetate, isoamyl isovalerianate, hexanol, hexanal, cis-3-hexenol, linalool, alpha-terpineol, cis and trans carvyl acetate, p-cymene, thymol, 4,8-dimethyl-3,7-nonadien-2-one, damascenone, damascone, rose oxide, dimethyl sulfide, fenchol, acetaldehyde diethyl acetal, cis-4-heptenal, isobutyraldehyde, isovaleraldehyde, cis-jasmone, anisaldehyde, methyl salicylate, myrtenyl acetate, 8-ocimenyl acetate, 2-phenylethyl alcohol, 2-phenylethyl isobutyrate, 2-phenylethyl isovalerate, cinnamaldehyde, geraniol, nerol, 2,2,5,5-tetramethyl-1,3-dioxane, 2,2,5-trimethyl-1,3-dioxane, 2,5,5-trimethyl-2-isopropyl-1,3-dioxane and 2,5-dimethyl-2-isopropyl-1,3-dioxane.

In the case of chiral compounds, the above flavourings can be present as a racemate or as an individual enantiomer or as an enantiomer-enriched mixture.

Examples of other taste compounds that can be advantageously combined with the (−)-carvone acetals according to the invention are e.g. substances with a physiological cooling action, i.e. substances which cause a sensation of cold in the mucous membranes. These cooling agents are e.g. 1-menthol, 1-isopulegol, menthone glycerin acetal, menthyl lactate, substituted menthane-3-carboxamides (e.g. menthane-3-carboxylic acid-N-ethylamide), 2-isopropyl-N,2,3-trimethylbutanamide, 3,3,5-trimethylcyclohexanol, 3-menthoxy-1,2-propanediol, 3-menthoxy-2-methyl-1,2-propanediol, 2-menthoxyethanol, 2-menthoxypropanol, 3-menthoxypropanol, 4-menthoxybutanol, 2-hydroxyethyl menthyl carbonate, 2-hydroxypropyl menthyl carbonate, glycerin menthyl carbonate, N-acetyl glycine menthyl ester, menthyl hydroxycarboxylates (e.g. menthyl-3-hydroxybutyrate), menthane-3,8-diol, menthyl-2-methoxyacetate, menthyl-2-(2-methoxyethoxy) acetate, menthyl monosuccinate, 2-mercaptocyclodecanone, menthyl-2-pyrrolidin-5-one carboxylate.

The use of the (−)-carvone acetals according to the invention is also advantageous in combination with other substances causing a pungent taste or a sensation of warmth or heat on the skin and mucous membranes or a tingling or prickling sensation in the oral and pharyngeal cavities, such as e.g. powdered paprika, chilli powder, extracts of paprika, extracts of pepper, extracts of chilli, extracts of ginger roots, extracts of grains of paradise (Aframomum melegueta), extracts of paracress (Jambu oleoresin; Spilanthes acmella or Spilanthes oleracea), extracts of Japanese pepper (Zanthoxylum piperitum), extracts of Kaempferia galanga, extracts of Alpinia galanga, extracts of water pepper (Polygonium hydropiper), capsaicin, dihydrocapsaicin, gingerol, paradol, shogaol, piperine, saanshool-I, saanshool-II, sanshoamide, spilanthol, carboxylic acid-N-vanillylamides, especially nonanoic acid-N-vanillylamide, 2-nonenoamides, especially 2-nonenoic acid-N-isobutylamide, 2-nonenoic acid-N-4-hydroxy-3-methoxyphenylamide, alkyl ethers of 4-hydroxy-3-methoxybenzyl alcohol, especially 4-hydroxy-3-methoxybenzyl-n-butyl ether, alkyl ethers of 3-hydroxy-4-methoxybenzyl alcohol, alkyl ethers of 3,4-dimethoxybenzyl alcohol, alkyl ethers of 3-ethoxy-4-hydroxybenzyl alcohol, alkyl ethers of 3,4-methylenedioxybenzyl alcohol, acetals of vanillin, acetals of ethyl vanillin, acetals of isovanillin, (4-hydroxy-3-methoxyphenyl)acetamides, especially (4-hydroxy-3-methoxyphenyl)acetic acid-N-n-octylamide, allyl isothiocyanate, nicotinaldehyde, methyl nicotinate, propyl nicotinate, 2-butoxyethyl nicotinate, benzyl nicotinate, I-acetoxychavicol.

The (−)-carvone acetals according to the invention can be present in the flavour or taste compositions in a proportion of 0.1 to 99 wt. %. A content of 0.5 to 60 wt. % is preferred and a content of 5 to 40 wt. % is particularly preferred. In corresponding finished products, these flavour and taste compositions can be contained as 0.00001 to 50 wt. %, with a content of between 0.001 and 10 wt. % being preferred and a content of 0.01 to 5 wt. % being particularly preferred.

The flavour or taste compositions containing the (−)-carvone acetals according to the invention can be used and incorporated into ready-to-use products in pure form, as solutions or in a specially prepared form.

Suitable as solvents are e.g. ethyl alcohol, 1,2-propylene glycol, triacetin, benzyl alcohol and fatty oils, such as e.g. coconut oil or sunflower seed oil.

The flavour or taste compositions containing the (−)-carvone acetals according to the invention can also contain additives and auxiliary substances, such as e.g. preservatives, colours, antioxidants, flow control agents and thickeners.

In specially prepared forms, the flavour or taste compositions containing the (−)-carvone acetals according to the invention can be bound to a support or be present in spray-dried or encapsulated form.

Suitable supports for the bound form can be e.g. salt, sugar, starches or molten sugars.

The spray-dried form is conventionally produced from the liquid compositions by producing an emulsion with the addition of specific quantities of a support substance, preferably biopolymers such as starch, modified starches, maltodextrins and gum arabic. This emulsion is dried in spray driers by ultrafine division with simultaneous application of heat. A powder results with the desired load of liquid flavour or taste composition.

The encapsulated form is also conventionally produced from the liquid compositions by adding a support substance. There are various technologies by means of which capsules can be produced. The most common are extrusion, spray granulation and coacervation. The particle sizes generally range from 10 μm to 5 mm. The most common capsule materials are various starches, maltodextrin and gelatine. The liquid or solid flavour or taste compositions are enclosed in these capsules and can be released by various mechanisms, such as heat application, pH shift or pressure from chewing.

The (−)-carvone acetals according to the invention are suitable for the production of flavour or taste compositions with many different taste orientations.

The (−)-carvone acetals are particularly suitable for use in flavour and taste compositions with a fresh, minty and cooling taste. These fresh, minty and cooling taste compositions are substantially characterised in that, in addition to the (−)-carvone acetals according to the invention, they preferably contain a component from the group comprising peppermint oils, Mentha arvensis oils, spearmint oils, eucalyptus oils, 1,8-cineol (eucalyptol), menthol, menthyl methyl ether and substances with a physiological cooling action.

The contents of the individual composition components in the flavour and taste compositions with a minty taste can vary, in general between 0.1 and 99.9 wt. %.

Mint compositions containing 0.5 to 30 wt. % of the (−)-carvone acetals according to the invention and one or more components selected from the group comprising menthol, menthone, peppermint or Mentha arvensis oils, spearmint oils, eucalyptol or eucalyptus oils containing eucalyptol, and substances with a physiological cooling action are preferably used.

Menthol can be contained here in a concentration of 1 to 90 wt. %, menthone in a concentration of 1 to 70 wt. %, peppermint or Mentha arvensis oils in a concentration of 1 to 90 wt. %, spearmint oils in a concentration of 1 to 90 wt. %, eucalyptol or eucalyptus oils containing eucalyptol in a concentration of 1 to 90 wt. % and substances with a physiological cooling action in a concentration of 0.5 to 90 wt. %.

Mint compositions containing 1 to 10 wt. % of the (−)-carvone acetals according to the invention and at least two components selected from the group of the components menthol, menthone, peppermint or Mentha arvensis oils, spearmint oils, eucalyptol or eucalyptus oils containing eucalyptol and substances with a physiological cooling action are particularly preferably used.

Menthol can be contained here in a concentration of 20 to 60 wt. %, menthone in a concentration of 5 to 30 wt. %, peppermint or Mentha arvensis oils in a concentration of 5 to 60 wt. %, spearmint oils in a concentration of 5 to 60 wt. %, eucalyptol or eucalyptus oils containing eucalyptol in a concentration of 2 to 50 wt. % and substances with a physiological cooling action in a concentration of 1 to 30 wt. %.

Substances with a physiological cooling action can be those described above, and can be used individually or as mixtures. Advantageous mixtures of substances with a physiological cooling action contain at least one component, preferably at least two components, selected from the group of the following substances: menthone glycerin acetal, menthyl lactate, substituted menthyl-3-carboxamides (e.g. menthyl-3-carboxylic acid-N-ethylamide), 2-hydroxyethyl menthyl carbonate and 2-hydroxypropyl menthyl carbonate.

In these mixtures of substances with a physiological cooling action, the individual components are preferably contained in the following concentrations: menthone glycerin acetal 1 to 99 wt. %, menthyl lactate 1 to 99 wt. %, menthyl-3-carboxylic acid-N-ethylamide 1 to 99 wt. %, 2-hydroxyethyl menthyl carbonate 1 to 99 wt. % and 2-hydroxypropyl menthyl carbonate 1 to 99 wt. %.

The following concentrations are particularly preferred: menthone glycerin acetal 1 to 70 wt. %, menthyl lactate 1 to 70 wt. %, menthyl-3-carboxylic acid-N-ethylamide 1 to 70 wt. %, 2-hydroxyethyl menthyl carbonate 1 to 70 wt. % and 2-hydroxypropyl menthyl carbonate 1 to 70 wt. %.

By adding other flavourings, e.g. of the sweet, sweet-aromatic, fresh or fruity type or optionally also other taste orientations, the taste of these mint compositions can be modified, the proportion by weight of the flavourings added generally being 0.001 to 50 wt. %, based on the proportion by weight of the active minty and cooling substances. An addition of 0.01 to 30 wt. % is preferred and an addition of 0.1 to 10 wt. % is particularly preferred, based on the proportion by weight of the active minty and cooling substances.

By using the (−)-carvone acetals according to the invention in such compositions, a pleasant spearmint taste and a marked minty fresh effect is achieved in the oral and pharyngeal cavity. The flavour intensity, the fullness of flavour and particularly the freshness of the mint compositions are increased and the fresh, cooling action of the substances with a physiological cooling action are intensified and prolonged.

The flavour and taste compositions with a minty taste containing the (−)-carvone acetals according to the invention can be advantageously employed particularly in oral care products, such as toothpastes and mouthwashes, chewing gums, foods, such as confectionery and boiled sweets, and pharmaceutical preparations.

The content of the flavour and taste compositions with a minty taste containing the (−)-carvone acetals according to the invention is 0.01 to 1 wt. % in ready-to-use mouthwashes, with a content of 0.1 to 0.3 wt. % being particularly preferred. In mouthwash concentrates, the content of the compositions containing the (−)-carvone acetals according to the invention is between 0.01 and 20 wt. %, with a content of 0.1 to 10 wt. % being preferred and a content of 3 to 5 wt. % particularly preferred. In toothpastes and chewing gums, the compositions containing the (−)-carvone acetals according to the invention are used in a concentration of between 0.1 and 5 wt. %, with a content of 0.5 to 2 wt. % being preferred. A content of between 0.8 and 1.5 wt. % is particularly preferred. In boiled sweets, the content of the compositions containing the (−)-carvone acetals according to the invention is between 0.01 and 2 wt. %, with a content of 0.05 to 1 wt. % being preferred and a content of between 0.1 and 0.5 wt. % particularly preferred.

Toothpastes flavoured with the flavour or taste compositions containing the (−)-carvone acetals according to the invention generally contain an abrasive system (grinding or polishing agent), such as e.g. silica, calcium carbonates, calcium phosphates, aluminium oxides and/or hydroxyl apatites, surface-active substances, such as e.g. sodium lauryl sulfate, sodium lauryl sarcosinate and/or cocamidopropyl betaine, humectants, such as e.g. glycerin and/or sorbitol, thickeners, such as e.g. carboxymethylcellulose, polyethylene glycols, carrageenans and/or Laponite®, sweeteners, such as e.g. saccharin and/or aspartame, stabilisers and active ingredients, such as e.g. sodium fluoride, sodium monofluorophosphate, tin difluoride, quaternary ammonium fluorides, zinc citrate, zinc sulfate, tin pyrophosphate, tin dichloride, mixtures of various pyrophosphates, triclosan, cetylpyridinium chloride, aluminium lactate, potassium citrate, potassium nitrate, potassium chloride, sodium chloride, strontium chloride, hydrogen peroxide and/or sodium bicarbonate.

Chewing gums flavoured with the flavour or taste compositions containing the (−)-carvone acetals according to the invention generally consist of a chewing gum base, that is to say a masticatory substance becoming plastic during chewing, sugars of various types, sugar substitutes, sweeteners, sugar alcohols, humectants, thickeners, emulsifiers and stabilisers.

When finished products are used which contain flavour or taste compositions with the (−)-carvone acetals according to the invention, it is shown that the (−)-carvone acetals according to the invention or the flavour or taste compositions containing the (−)-carvone acetals according to the invention are also particularly suitable for freshening the breath and neutralising or reducing unpleasant mouth odour.

The use of the (−)-carvone acetals according to the invention or the flavour or taste compositions containing the (−)-carvone acetals according to the invention in oral care products, such as e.g. mouthwashes, toothpastes and chewing gums, leads to the masking or neutralising of unpleasant, particularly bitter or astringent taste impressions caused by substances such as e.g. triclosan, zinc citrate, zinc sulfate, poly- and pyrophosphates, bicarbonates, strontium and potassium salts, tin pyrophosphate, tin chloride, aluminium lactate, hydrogen peroxide, fluorides, vitamins, cetylpyridinium chloride, and emulsifiers, such as e.g. in particular sodium lauryl sulfate, sodium lauryl sarcosinate and cocamidopropyl betaine, and sweeteners, such as e.g. aspartame, saccharin, acesulfame-K, sorbitol, xylitol, cyclamates (e.g. sodium cyclamate), sucralose, alitame, neotame, thaumatin, neohesperidine DC, maltitol, lactitol or chewing gum bases.

The (−)-carvone acetals according to the invention or the flavour or taste compositions containing the (−)-carvone acetals according to the invention are also particularly suitable for use in pharmaceutical preparations, such as e.g. throat or cough sweets. Because of their excellent stability in alkaline media, they are also outstandingly suitable for the flavouring of antacids. They are also suitable for masking the bitter taste of orally-administered medicines.

The following examples explain the invention:

### EXAMPLE 1

### (−)-Carvone Dimethyl Acetal

15 g (−)-carvone are added rapidly, in one portion at room temperature, to a mixture of 16.1 g trimethyl orthoformate, 20 ml methanol and 10 mg p-toluenesulfonic acid. After stirring for 5 min, 2 g soda are added. The reaction mixture is filtered, the highly volatile components are drawn off and the residue obtained is taken up in diethyl ether and washed until neutral. After concentrating by evaporation, a residue is obtained which consists of one third (−)-carvone dimethyl acetal and two thirds unreacted (−)-carvone. Pure (−)-carvone dimethyl acetal is obtained by rectification using a Spaltrohr® column (Fischer Technology GmbH), b.p. 84° C./2.6 mbar.

Mass spectrum: m/z (%)=196 (M+, 3); 181 (13); 165 (78); 149 (21); 138 (29); 128 (43); 123 (100); 113 (38); 91 (29); 79 (16); 69 (10); 53 (14); 41 (19).

Sensory evaluation: weak, slightly green odour, rather weakly of spearmint;

strong and typical (−)-carvone and spearmint taste.

### EXAMPLE 2

### (−)-Carvone Diethyl Acetal

(−)-Carvone diethyl acetal was prepared in the same way as (−)-carvone dimethyl acetal. B.p. 82° C./1 mbar.

Mass spectrum: m/z (%)=224 (M+, 2); 209 (13); 179 (100); 156 (34); 152 (28); 137 (40); 123 (22); 109 (76); 100 (29); 91 (18); 82 (15); 67 (10); 55 (12); 43 (21).

Sensory evaluation: weak, not very characteristic odour;

strong and typical (−)-carvone and spearmint taste.

### EXAMPLE 3

### (−)-Carvone Ethylene Glycol Acetal

A mixture of 150 g (−)-carvone, 124 g ethylene glycol, 500 ml toluene and 2 g powdered potassium hydrogensulfate was boiled with reflux in a water separator until no more water was separated. The reaction mixture was filtered, washed with water and neutralised. After drawing off the solvent, the (−)-carvone ethylene glycol acetal was obtained in pure form by fractionating the residue using a Spaltrohr® column. B.p. 83° C./0.9 mbar.

Mass spectrum: m/z (%)=194 (M+, 2); 179 (1); 139 (13); 126 (100); 114 (5); 99 (9); 82 (21); 67 (7); 53 (7); 41 (11).

Sensory evaluation: weak, somewhat solvent-like odour;

strong and typical (−)-carvone and spearmint taste.

### EXAMPLE 4

### (−)-Carvone 1,2-propylene glycol acetal

(−)-Carvone 1,2-propylene glycol acetal was prepared in the same way as (−)-carvone ethylene glycol acetal from (−)-carvone and 1,2-propylene glycol. B.p. 101° C./2 mbar.

Mass spectrum: m/z (%)=208 (M+, 3); 153 (13); 140 (100); 128 (5); 95 (16); 82 (47); 67 (7); 54 (7); 41 (11).

Sensory evaluation: weak, somewhat solvent-like odour;

strong and typical (−)-carvone and spearmint taste.

### EXAMPLE 5

### (−)-Carvone 1,2-butylene glycol acetal

(−)-Carvone 1,2-butylene glycol acetal was prepared in the same way as (−)-carvone ethylene glycol acetal from (−)-carvone and 1,2-butylene glycol. B.p. 96° C./0.3 mbar.

Mass spectrum: m/z (%)=222 (M+, 2); 167 (7); 154 (100); 100 (28); 82 (33); 55 (32); 41 (11).

Sensory evaluation: weak, somewhat solvent-like odour;

strong and typical (−)-carvone and spearmint taste.

### EXAMPLE 6

### (−)-Carvone 2,3-butylene glycol acetal

(−)-Carvone 2,3-butylene glycol acetal was prepared in the same way as (−)-carvone ethylene glycol acetal from (−)-carvone and 2,3-butylene glycol. B.p. 109° C./5 mbar.

Mass spectrum: m/z (%)=222 (M+, 1); 167 (5); 154 (100); 119 (7); 95 (7); 82 (63); 67 (5); 55 (7); 41 (8).

Sensory evaluation: weak, somewhat solvent-like odour;

strong and typical (−)-carvone and spearmint taste.

### EXAMPLE 7

### Toothpaste Flavour for Use in a Bicarbonate Toothpaste

By mixing
30 wt. % (−)-carvone 1,2-propylene glycol acetal,
5 wt. % anethole,
50 wt. % peppermint oil arvensis, rectified, and
15 wt. % peppermint oil Willamette,
   a toothpaste flavour of the spearmint type is produced, which is incorporated at a concentration of 1.2 wt. % into a toothpaste base consisting of 65 wt. % sodium bicarbonate. The toothpaste was tested under practical conditions and evaluated by a panel of experts with sensory training. A fine, strong, spearmint taste was noted which, in contrast to a corresponding flavour with (−)-carvone or spearmint oil containing (−)-carvone, did not change even after a prolonged storage period.

1. A flavouring agent comprising a (−)-carvone acetal of the general formula (I) 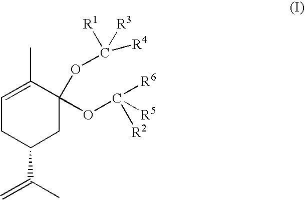
wherein:
R¹ to R⁶ independently of one another denote hydrogen or an alkyl group with 1 to 4 carbon atoms; or optionally R⁴ and R⁶ together denote a carbon single bond or a —(CR⁷R⁸)ₓ_{^{−}} group,
x can take on the values 1 or 2, and
R⁷ and R⁸ independently of one another denote hydrogen or an alkyl group with 1 to 4 carbon atoms.

2. A flavoring agent according to claim 1, wherein, R¹ to R⁶ denote a hydrogen atom or R¹ and R² independently of one another denote an alkyl group with 1 to 4 carbon atoms and R³ to R⁶ a hydrogen atom or the residues R⁴ and R⁶ together denote a carbon single bond and R¹, R², R³ and R⁵ independently of one another denote a hydrogen atom or an alkyl group with 1 to 4 carbon atoms.

3. A flavoring agent according to claim 1, wherein said (−)-carvone acetal is (−)-carvone dimethyl acetal, (−)-carvone diethyl acetal, (−)-carvone ethylene glycol acetal, (−)-carvone 1,2-propylene glycol acetal, (−)-carvone 1,2-butylene glycol acetal or (−)-carvone 2,3-butylene glycol acetal.

4. A (−)-carvone acetal selected from the group consisting of (−)-carvone dimethyl acetal, (−)-carvone diethyl acetal and (−)-carvone 1,2-butylene glycol acetal.

5. A method for adding flavor to a product comprising adding to said product a flavouring agent according to claim 1.

6. A flavouring agent according to claim 1 comprising a content of (−)-carvone acetals of 0.5 to 60 wt. %.

7. A product selected from foods and items consumed for pleasure, body care products and pharmaceutical preparations, containing the flavouring agent of claim 1.

8. A product according to claim 7 comprising body care products in the form of toothpastes, tooth gels, dental creams, dental care chewing gums or mouthwashes.

9. A product according to claim 7 having a pH greater than or equal to 7.5.

10. A method according to claim 5 comprising adding 0.5 to 60 wt % of said flavouring agent.

11. A method according to claim 5 wherein said product is selected from the group consisting of foods, items consumed for pleasure, body care products and pharmaceutical preparations.
